(19) United States
(12) Patent Application Publication
(10) Pub. No.: US 2005/0005752 A1
(43) Pub. Date: Jan. 13, 2005

(54) Power miter saw

(76) Inventors: Wang Xin, Pingjiang District of Suzhou (CN); Liu Changning, Suzhou (CN); Kong Zhao, Suzhou (CN)

Correspondence Address: FULWIDER PATTON LEE & UTECHT, LLP, 200 OCEANGATE, SUITE 1550, LONG BEACH, CA, 90802, US

(21) Appl. No.: 10/879,376

(22) Filed: Jun. 28, 2004

(30) Foreign Application Priority Data
Jun. 30, 2003 (CN) 03259269.8

(51) Int. Cl. B23D 45/04

(52) U.S. Cl. 83/397; 83/473; 83/490; 83/478

(57) ABSTRACT

The present invention relates to a quick actuating mechanism for a movable guard of miter saw, the mechanism comprises: a mounting arm 7, a fixed guard 3, a drive means and a circular saw blade 6, a movable guard 5 is pivotally connected to the fixed guard 3, the movable guard 5 is pivotally connected to the front end of the actuating link 2 by a second pin 4, the rear end of the actuating link 2 is movably connected to the mounting arm 7, a first pin 1 is disposed on the rear end of the actuating link 2, the mounting arm 7 has a first arcual slide slot 8 with which the first pin 1 engages. When the fixed guard moves together with a saw unit of the miter saw downwardly, the actuating link pivotally engages with the first slide slot and actuates the movable guard rapidly to open. The present design of the movable guard of a miter saw can be easily manufactured and conveniently assembled or adjusted so as to the cost reduced.

### BACKGROUND INFORMATION

In the Prior Art, U.S. 4,805,504 discloses a quick actuating mechanism for the movable guard of the power miter saw, of which at two ends of an actuating link has the cam grooves, but the cam grooves is hard to manufacture and the curve is hard to control. EP0407204B discloses an arcuate slide slot mechanism, and the guiding member which causes the sliding movement of the movable guard is fixed on the safe guard, so that it is complexly in assembly and inconveniently in adjustment and need high mounting precise. U.S. Pat. No. 5,203,245 discloses a construction, which comprises a slide slot in actuating link and a link control bearing in fixed guard, but it is hard to manufacture for the complexity of the slide slot.

### SUMMARY OF THE INVENTION

It is an object of the invention to provide a brief-structured and speedy-actuated quick actuating mechanism for the movable guard of the power miter saw,

The principle of this invention is: a quick actuating mechanism for the movable guard of mite saw comprising: a mounting arm, a fixed guard pivotally connected to the mounting arm by a rotating shaft, a drive means and a circular saw blade fixedly connected to the output rotating shaft of the drive means, a movable guard pivotally connected to the fixed guard by the rotating shaft of the movable guard, a second pin disposed on the movable guard in an offset position relative to the rotating shaft of the movable guard, the movable guard pivotally connected to the front end of an actuating link through the second pin, the rear end of the actuating link movably connected to said mounting arm, a first pin disposed on the rear end of the actuating link, a first arcual slide slot formed on the mounting arm, the first pin engages with the first slide slot.

Comparing with the prior arts, the present invention has the following advantages: When the fixed guard is pressed downward, the actuating link speedily actuates the movable guard to open. The present design of the movable guard of a miter saw can be easily manufactured and conveniently assembled or adjusted so as to the cost reduced.

### BRIEF DESCRIPTION OF THE DRAWINGS

FIG. 1 is the front view of the present invention with the fixed guard raised in a highest position;

FIG. 2 is the front view of the present invention with the fixed guard is pressed downwardly a small distance from the position of FIG. 1;

FIG. 3 is the front view of the present invention with the fixed guard in its lowest position;

FIG. 4 is the top view of the present invention;

FIG. 5 is the section view taken along line A-A of the FIG. 2;

FIG. 6 is the view taken from the direction of B of the FIG. 5;

FIG. 7 is the partly enlarged view of the mounting arm to show the first arctuate slide slot;

1.a first pin; 2.a actuating link; 3.a fixed guard; 4.a second pin; 5.a movable guard; 6.a circular saw blade; 7.a mounting arm; 8.a first slide slot; 9.a rotating shaft; 10.a support base; 11.a fence; 12.a workpiece; 13.a turntable; 14.a third slide slot; 15.a washer; 16.a connecting bolt; 17.a electric motor; 18.a handle; 19.a third pin; 20.a second slide slot; 21.a rotating shaft of the movable guard; 22.a output rotating shaft;

### DESCRIPTION OF THE PREFERED EMBODIMENTS

The following detailed description illustrates the invention by way of example and not by way of limitation.

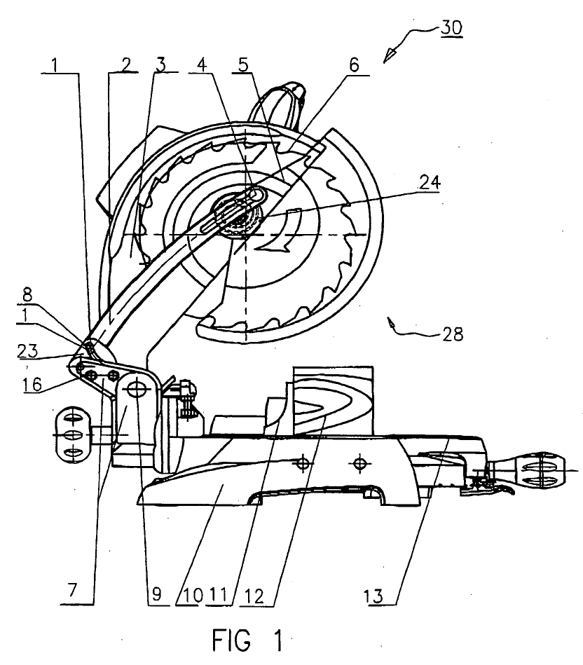

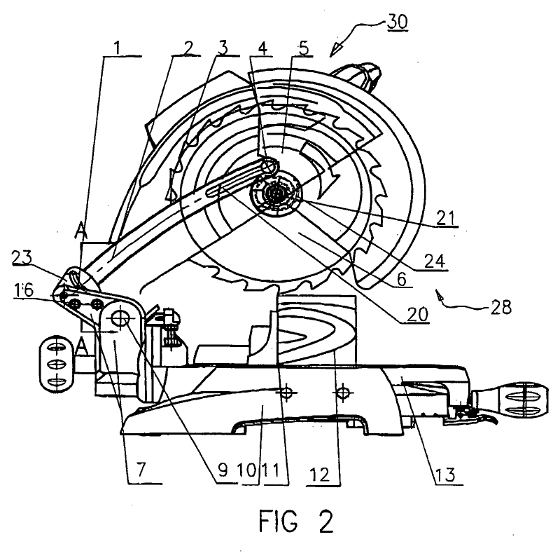

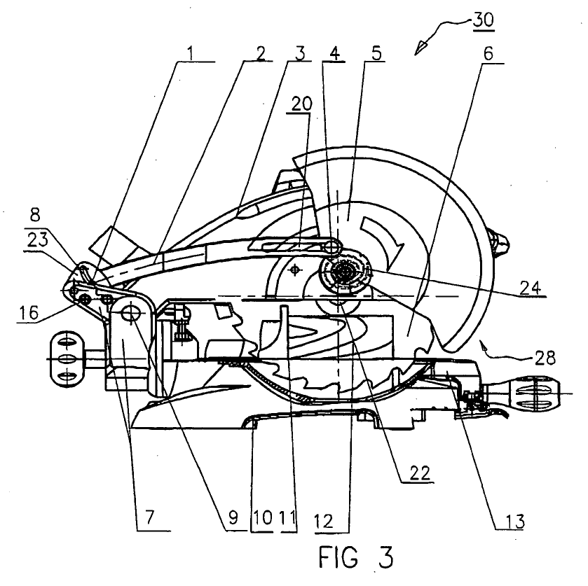

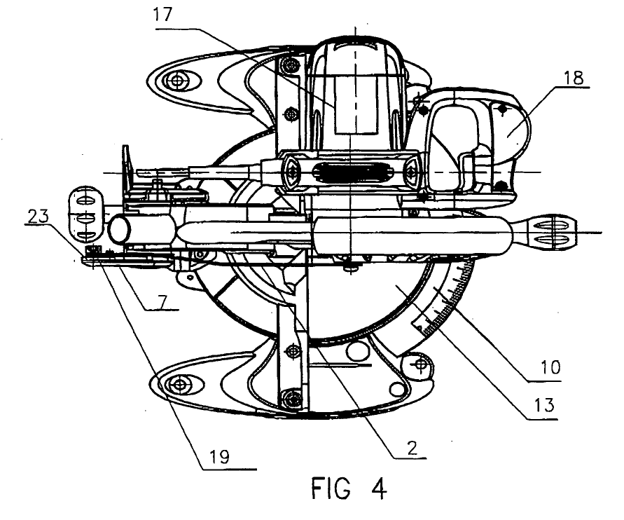

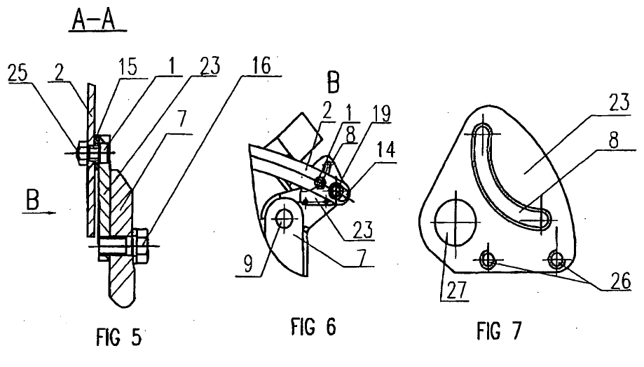

Referring to FIG. 1 to FIG. 7, the powered or compound miter saw includes circular saw blade 6 which is rotatably mounted within a fixed guard 3 and is power driven by an electric motor 17. A handle 18 for raising and lowering the power driven saw blade between an upper at rest and lower operational position is mounted to the front or operator side of the power miter saw. A turntable 13 is rotatablely mounted within a support base 10. A fence 11 supported on the turntable 13 for stablely support a workpiece 12, which will be cut by the power miter, saw. A quick actuating mechanism for the movable guard of miter saw comprises a mounting arm 7 mounted on a support base 10 for movement of the rotatably saw unit from an upper at rest to a lower operational or full cut position. A fixed guard 3 pivotally connected to the mounting arm 7 by a rotating shaft 9. A circular saw blade 6 fixedly connected to an output rotating shaft 22 of a drive means which driven by the electric motor 17. A movable guard 5 pivotally connected to the fixed guard 3 by a rotating shaft 21, which connected to the movable guard. A second pin 4 disposed on the movable guard 5 in an offset position relative to the rotating shaft 21 of the movable guard 5. The movable guard 5 pivotally connected to a front end of an actuating link 2 by the second pin 4. The rear end of the actuating link 2 movably connected to the mounting arm 7. A first pin 1 disposed on the rear end of the actuating link 2, a first arcual slide slot 8 formed on the mounting arm 7, the first pin 1 received in the first slide slot 8. The first slide slot 8 protrudes rearward. The shape of the first slide slot is able to be altered to multiple curved profiles which make the actuating link 2 generate a distance in the substantial longitudinal direction of the actuating link 2 during the saw unit from an upper at rest position to a lower operational position.

Referring to FIG. 6, the rear end of the actuating link 2 is movably connected to the mounting arm 7 by a third pin 19. In the preferred embodiment of the invention, a third slide slot 14 formed on the rear end of the actuating link 2 and the third pin 19 received in the third slide slot 14. The third pin 19 moves along the slide slot 14 and rotates in the third slide slot 14 relative to the mounting arm when the fixed guard is pressed downward.

Referring to FIG. 1, the second slide slot 20 extending substantially in the longitudinal direction of the actuating link is formed on the front end of the actuating link 2, the second pin 4 engages with the second slide slot 20. The second slide slot 20 is for the operator able to manually upwardly turn the movable guard 5 when the circular saw blade needed to be changed with a new one.

1. A quick actuating mechanism for the movable guard of miter saw, comprising: a mounting arm (7), a fixed guard (3) pivotally connected to said mounting arm (7) by a rotating shaft (9), a drive means and a circular saw blade (6) fixedly connected to the output rotating shaft (22) of said drive means, a movable guard (5) pivotally connected to said fixed guard (3) by a rotating shaft (21) of said movable guard (5), characterized in that: a second pin (4) disposed on said movable guard (5) in an offset position relative to said rotating shaft (21) of said movable guard (5), said movable guard (5) pivotally connected to a front end of an actuating link (2) by said second pin (4), a first pin (1) disposed on said rear end of said actuating link (2), a first arcual slide slot (8) formed on the mounting arm (7), a rear end of said actuating link (2) movably connected to said mounting arm (7) by said first pin (1) engaging with said first arcual slide slot (8).

2. A quick actuating mechanism for the movable guard of miter saw of claim 1, wherein a third pin (19) is disposed on said mounting arm (7), a third slide slot (14) formed on said rear end of said actuating link (2), said rear end of said actuating link (2) movably connected to said mounting arm (7) by said third pin (19) engaging with said third slide slot (14).

3. A quick actuating mechanism for the movable guard of miter saw of claim 1, wherein a second slide slot (20) which extending in substantial longitudinal direction of said actuating link (2) formed on the front end of said actuating link (2), said second pin (4) engaging with said second slide slot (20);

4. A quick actuating mechanism for the movable guard of miter saw of claim 1, wherein said first arcual slide slot (8) protrudes towards to the rear side of said miter saw.
